(19) United States
(12) Patent Application Publication
(10) Pub. No.: US 2010/0088938 A1
(43) Pub. Date: Apr. 15, 2010

(54) Transparent Pocket to hold business/ID card onto Luggage Strap

(76) Inventor: Errol Rowland, Aurora, CO (US)

Correspondence Address: Errol Rowland, 2677-D S Xanadu Way, Aurora, CO, 80014, US

(21) Appl. No.: 12/576,244

(22) Filed: Oct. 9, 2009

Related U.S. Application Data
(60) Provisional application No. 61/105,274, filed on Oct. 14, 2008.

(51) Int. Cl. G09F 3/20

(52) U.S. Cl. 40/654.01

(57) ABSTRACT

An identification device including a flexible securing transparent cover element and a securing element. The transparent tag includes a three sided attachment to a luggage shoulder strap by which to insert an identification plate or the like. The transparent cover of the device is unattached to the shoulder strap at one side for access to the identification element and easy replacement.

This application emanates from a previously filed application 61/105,274 Oct. 14, 2008.

### FIELD OF THE INVENTION

This invention relates to identification tags for use on luggage and the like, and more particularly, to identification tags which are transparent or semi-transparent in nature, and facilitate viewing of an indicia-carrying sheet or plate through transparent superimposed plates or elements.

### BACKGROUND OF THE INVENTION

A number of types and designs of identification tags suitable for attachment to luggage and the like have heretofore been devised. Such tags must meet several criteria in order to enjoy the widest acceptance by luggage owners. First, the tags preferably are of a permanent or semipermanent nature in the sense of being rugged and sufficiently resistant to crumpling or abrasion that the tags can withstand the rigors of careless handling of the luggage which is frequently experienced during transit. Further, identification tags are preferably aesthetic in character, and do not present an unsightly appendage to the luggage. Since luggage is often selected largely on the basis of its aesthetic quality, it is important that the identification tag complement the luggage, and be smart and neat in appearance.

Another desideratum in luggage identification tags is the capability of quickly placing certain identifying and descriptive indicia on the tag, and of altering or replacing such indicia quickly and easily at any time that it is desirable to do so. For example, where the owner's address is changed, or where the luggage is given as a gift to a person who may wish to place indicia of his or her choice on the identification tag, it is important that the placement of the identifying indicia or marks on the tag can be accomplished quickly, without special tools, and in such manner that the marks conveying the desired information to a viewer can be erased or at least quickly changed in the event different information becomes appropriate to include on the tag.

A number of types of identification tags have heretofore been proposed and used with varying degrees of success for the purpose of affixation to luggage, and conveyance of meaningful information to an observer.

A generally similar type of structure is provided in the form of a combined key chain and locket as shown in Arnold U.S. Pat. No. 760,410. Here, a cover plate or panel of generally elliptical configuration is retained over a similarly shaped recessed panel which functions to receive in the recess some type of indicia-carrying card which will function to identify the owner of the keys carried on a key chain attached to the superimposed panels or plates. The key chain links can be extended through a hollow rivet used to join the two plates to each other.

In Kocsi U.S. Pat. No. 2,720,777, a structure is provided in which a pair of superimposed clear or transparent plastic plates 16 and 18 sandwich between them an indicia-bearing card or element, with such indicia being visible through the plastic plates at the opposite sides of the superimposed plastic elements.

### SUMMARY OF THE INVENTION

The present invention provides an improved identification device susceptible to rapid affixation to luggage or the like, which device can be economically manufactured, is rugged and durable in use, and which facilitates, during usage, the rapid placement of selected indicia on the device, or the changing of such indicia at any time.

The present invention overcomes disadvantages of the prior art.

Broadly described, the transparent pocket to hold business/ID card onto the luggage strap of the invention comprises a flexible securing element which can be formed as a rectangle with a portion or transparent section securely and accessibly attached to the luggage strap. The transparent section or cover is accessed through the upper most side whereas any standard business or identification card can be placed for easy visibility.

The present invention relates to an IDmyBag transparent pocket to hold business/ID card onto luggage strap. The transparent pocket is sewn onto a luggage strap with an open end into which an identification card can then be inserted into the pocket, identifying the person who owns the strap.

The objective of the invention is to add a transparent pocket that an ID card or business card can slip to a luggage strap

A transparent pocket that is sewn onto a luggage strap with an open end. An identification card can then be inserted into the pocket, identifying the person who owns the strap.

### BRIEF DESCRIPTION OF THE DRAWING

The advantages and features of the present invention will become better understood with reference to the following more detailed description and claims taken in conjunction with the accompanying drawings, in which like elements are identified with like symbols, and in which:

FIG. 1 is a front perspective view of the Transparent Pocket to hold Business/ID card onto Luggage Strap

### DETAILED DESCRIPTION OF THE INVENTION

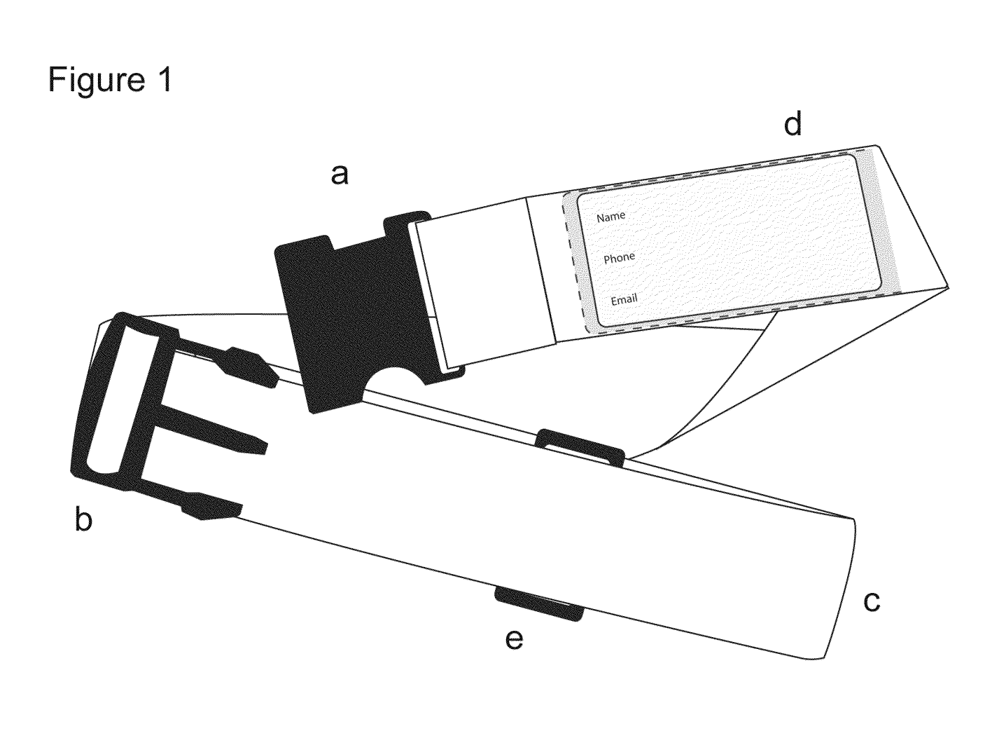

FIG. 1 depicts a front perspective view of my invention whereas the strap maintains two opposing ends, (a,b). A female connecting end (a) is located on one end and a male connecting end (b) is located on the opposite end of the strap. The purpose of the strap (c) is to wrap around the bag to secure the bag and to identify it from other bags that may appear similar. A transparent pocket (d) is provided to place identification information, further distinguishing and identifying the bag the strap is wrapped around. A cinching slide (e) is provided to adjust the strap to accommodate various girth sizes of bags

What is claimed is:

1. A transparent pocket to hold business/ID card onto a luggage strap comprising a transparent cover permanently attached to a luggage carrying shoulder strap.

2. A A transparent pocket to hold business/ID card onto a luggage strap of claim 1 wherein one side of the transparent cover is left open for card insertion.

3. A transparent pocket to hold business/ID card onto a luggage strap of claim 1 wherein the transparent cover is removably attached to the luggage shoulder strap.

4. A transparent pocket to hold business/ID card onto a luggage strap of claim 1 wherein the transparent cover may be adjusted along the linear path of the luggage shoulder strap.

5. A transparent pocket to hold business/ID card onto a luggage strap of claim 1 wherein the transparent cover can removed and reattached to another luggage strap.
